(19) United States
(12) Patent Application Publication
(10) Pub. No.: US 2019/0388966 A1
(43) Pub. Date: Dec. 26, 2019

(54) METHODS OF FORMING THREE-DIMENSIONAL OBJECTS USING ADDITIVE METAL MANUFACTURING

(71) Applicant: Desktop Metal, Inc., Burlington, MA (US)

(72) Inventors: Michael Andrew GIBSON, Boston, MA (US); Charles Edward MARTIN, Freedom, NH (US); Brian Daniel KERNAN, Andover, MA (US); Robert Michael SHYDO, JR., Pelham, NH (US)

(73) Assignee: Desktop Metal, Inc., Burlington, MA (US)

(21) Appl. No.: 16/445,863

(22) Filed: Jun. 19, 2019

Related U.S. Application Data
(60) Provisional application No. 62/687,958, filed on Jun. 21, 2018.

(51) Int. Cl. B22F 3/00; B29C 64/165; B29C 64/393; B33Y 10/00; B33Y 30/00; B33Y 50/02

(52) U.S. Cl. CPC B22F 3/008; B29C 64/165; B29C 64/393; B22F 2203/00; B33Y 30/00; B33Y 50/02; B33Y 10/00

(57) ABSTRACT

An additive manufacturing method including depositing a first amount of metal powder on a print bed, the first amount metal powder forming a first layer, depositing a first binder component to the first layer in a first region, and depositing a second binder component to the first layer in a second region.

### CROSS-REFERENCE TO RELATED APPLICATIONS

This application claims the benefit of U.S. Provisional Application No. 62/687,958, filed on Jun. 21, 2018, which is incorporated herein by reference in its entirety.

### DESCRIPTION

### Technical Field

Various aspects of the present disclosure relate generally to systems and methods for fabricating components using additive manufacturing.

### Background of the Disclosure

Powder bed three-dimensional fabrication is an additive manufacturing technique based on binding particles of a powder to form a three-dimensional object within the powder bed. Binder jetting is one type of powder bed three-dimensional fabrication. Binder jetting is based on the use of a binder to join particles of a powder to form a three-dimensional object. In particular, the binder is jetted onto successive layers of the powder in a powder bed such that the layers of the material adhere to one another to form a three-dimensional green part. For example, the binder material is deposited in a pre-determined pattern (e.g., in a cross-sectional shape of the three-dimensional object) to successive layers of powder in a powder bed such that the powder particles bind to one another where the binder material is located to form a three-dimensional green part. The binder provides strength to hold the shape of the green part as the green part undergoes subsequent processing, such as sintering, to form a densified final part. In the context of binder jet printing of three-dimensional metal objects, the three-dimensional green part may be formed by printing as described above, and may then be processed further into a finished three-dimensional metal part. For example, excess, unbound metal powder may be removed from the powder bed. Then, the three-dimensional green part may be heated in a furnace to remove the binder material and/or sintered to form the final, three-dimensional part.

Polymers can be used in the binder to provide green strength useful for holding the shape of the green part and, thus, for achieving target dimensions in the final part formed from the green part. However, there exists a tradeoff between green strength provided by polymers and the difficulty and cleanliness associated with removing the polymer to form the final part. For example, using more of a polymer to achieve green strength can result in more carbon being left behind during pyrolysis of the binder. In the formation of the final part, such an increase carbon can have a negative impact on properties of the metal forming the final part. As another example, a highly crosslinked polymer can be useful for achieving improved green strength, but increased crosslinking can also result in an increased amount of carbon in the metal forming the final part, as highly crosslinked polymers generally do not pyrolyze cleanly. Accordingly, there remains a need for polymer binders that can improve the strength of green parts formed through binder jetting while being cleanly removable from the green parts such that the green parts can be formed into high-quality metal parts.

The systems and methods of the current disclosure may rectify some of the deficiencies described above, and/or address other aspects of the prior art.

### SUMMARY OF THE DISCLOSURE

Examples of the present disclosure relate to, among other things, systems and methods for fabricating components using additive manufacturing. Each of the examples disclosed herein may include one or more of the features described in connection with any of the other disclosed examples.

For example, devices, systems, and methods are directed to selectively modifying binder formulations for binder jetting of three-dimensional objects. In general, as a three-dimensional object is being formed, the binder may be selectively modified to increase green strength of the three-dimensional part while facilitating clean removal of the polymer to reduce the likelihood of carbon contamination in a final metal part formed from the three-dimensional object. For example, selectively modifying the binder may include controlling distribution of two or more binder components to provide locally improved green strength while facilitating global removal of carbon contamination associated with removing the binder from the three-dimensional object to form a high-quality metal part.

### BRIEF DESCRIPTION OF THE DRAWINGS

The systems and methods described herein are set forth in the appended claims. However, for the purpose of explanation, several implementations are set forth in the accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1A is a schematic representation of an additive manufacturing system;

FIGS. 1B and 1C are schematic representations of exemplary binder jet fabrication subsystems of the additive manufacturing system of FIG. 1A;

FIG. 2 is a flowchart of an exemplary method of jetting a first component and a second component to layers of the powder in the powder bed to form the three-dimensional objects of FIGS. 1B and 1C;

FIG. 3 is a schematic representation of an additive manufacturing plant including the additive manufacturing system of FIG. 1A;

FIG. 4A is a side view of an exemplary three-dimensional object of FIGS. 1B and 1C;

FIG. 4B is a cross-sectional view of the three-dimensional object of FIG. 4A, the cross-section taken along the line 4B-4B in FIG. 4A;

FIG. 4C is a schematic representation of metallic particles dispersed in at least one ink in a layer of the three-dimensional object of FIGS. 1B and 1C, the schematic representation corresponding to the area of detail, 4C, shown in FIG. 4B;

FIG. 5 is a schematic representation of a layer of a three-dimensional object having a binder including a first component and a second component;

FIG. 6A is a schematic representation of in-situ polymerization via activation of oligomers, the oligomers including symmetrical end groups, and the activation yielding high molecular weight polymers from a series of the oligomers;

FIG. 6B is a schematic representation of in-situ polymerization via activation of oligomers, the oligomers including asymmetrical end groups, and the activation yielding high molecular weight polymers from a series of the oligomers; and

FIG. 7 is a schematic representation of in-situ polymerization via activation of oligomers and reaction with a cross-linking species.

### DESCRIPTION

Embodiments will now be described with reference to the accompanying figures. The foregoing may, however, be embodied in many different forms and should not be construed as limited to the illustrated embodiments set forth herein. Wherever possible, the same reference numbers will be used throughout the drawings to refer to the same or like parts.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose, e.g., to indicate a possible variation of +/−10% in the stated value. Ranges of values and/or numeric values are provided herein as examples only, and do not constitute a limitation on the scope of the described embodiments. Moreover, in the claims, values, limits, and/or ranges of various claimed elements and/or features means the stated value, limit, and/or range +/−10%. The terms “object,” “part,” and “component,” as used herein, are intended to encompass any object fabricated through the additive manufacturing techniques described herein. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

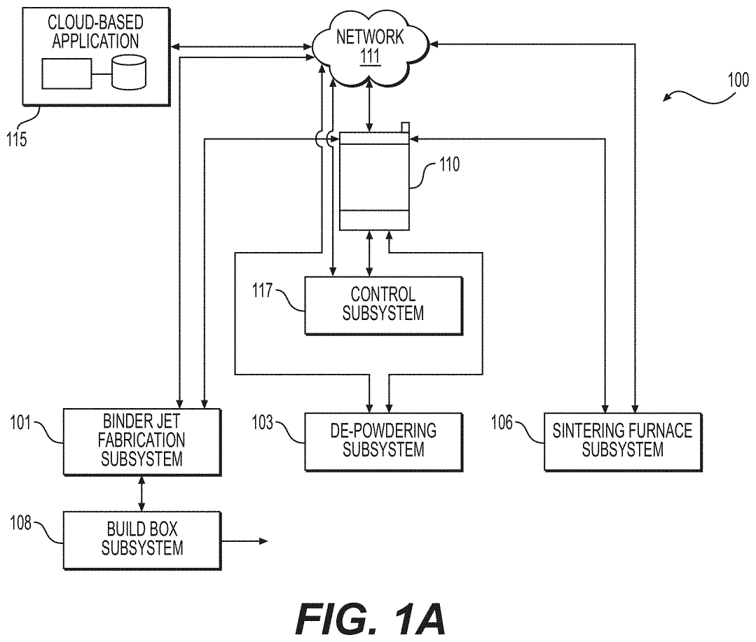

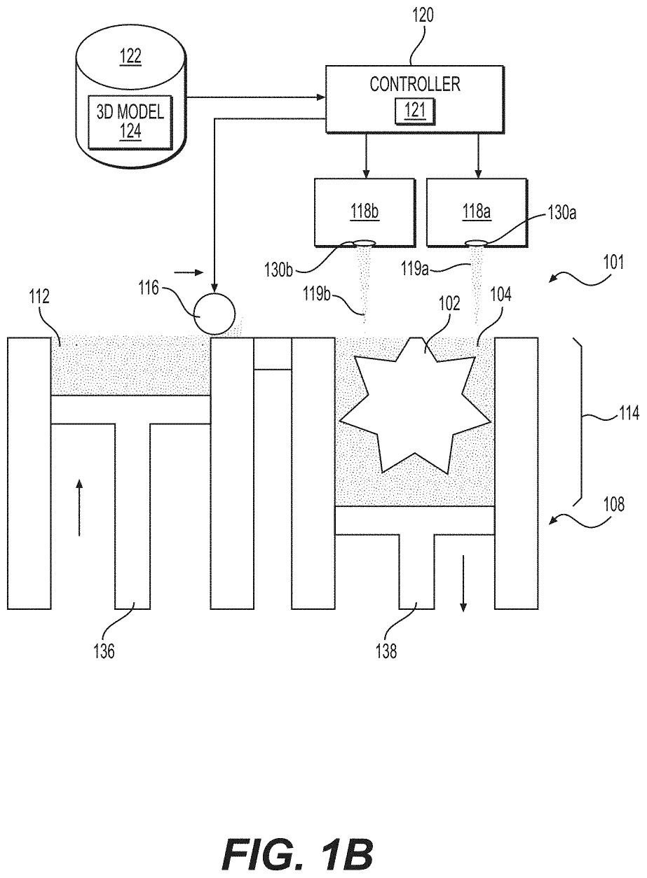

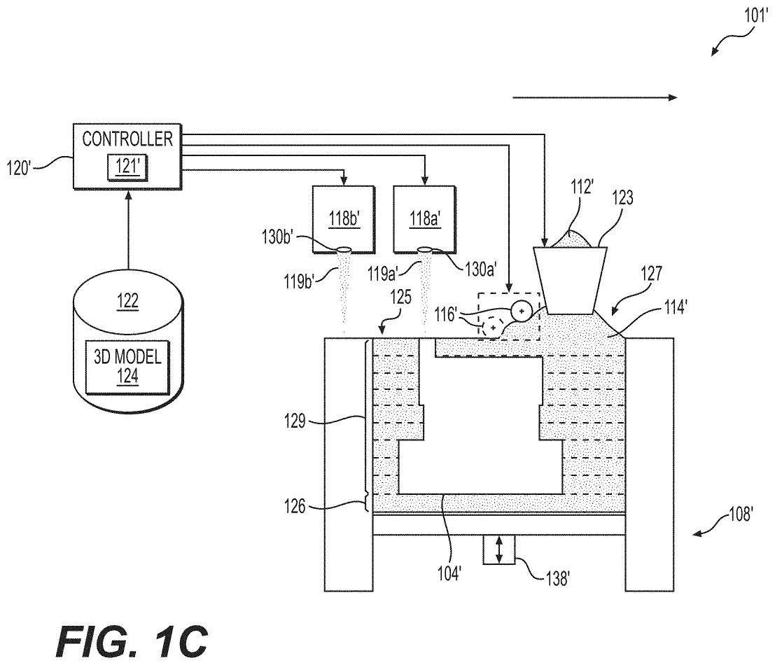

Referring now to FIG. 1A, an additive manufacturing system 100 may be used to form a three-dimensional object 102 (FIG. 1B) from a powder 104 including inorganic particles (e.g., metallic particles, ceramic particles, or a combination thereof). The three-dimensional object 102 is a great part that, as described in greater detail below, may be subsequently processed (e.g., thermally processed) to form a finished part having a predetermined local variation of one or more physicochemical properties of material formed from the inorganic particles of the powder 104. As used herein, physicochemical properties may include any manner and form of physical properties, chemical properties, or combinations thereof useful for forming a finished part. Examples of physicochemical properties that may be varied by the additive manufacturing system 100 carrying out any one or more of the methods described herein may include, but are not limited to, one or more of the following: melting point, hardness, density, ductility, chemical stability in a given environment, preferred oxidation state, etc.

With continued reference to FIG. 1A system 100 may include a printer, for example, a binder jet fabrication subsystem 101, and a treatment site(s), for example, a de-powdering subsystem 103 and a sintering furnace subsystem 106. Binder jet fabrication subsystem 101 may be used to form object 102 from a powder 104 (see FIG. 1B), for example, by delivering successive layers of powder 104 and binder material to a build area. As shown in FIG. 1B, a build box subsystem 108 may be movable and may be selectively positioned in one or more of binder jet fabrication subsystem 101, de-powdering subsystem 103, and sintering furnace subsystem 106. For example, build box subsystem 108 may be coupled or couplable to a movable assembly and may receive powder 104 to form object 102. Alternatively, a conveyor (not shown) may help transport the object between portions of system 100.

The build material may be a bulk metallic powder delivered and spread in successive layers. The binder material may be, for example, a polymeric liquid that may be deposited onto and may be absorbed into layers of the build material. One or more of binder jet fabrication subsystem 101, de-powdering subsystem 103, and sintering furnace subsystem 106 may include a shaping station to shape the printed object and a debinding station to treat the printed object to remove a binder material from the build material. Furnace subsystem 106 may heat and/or sinter the build material of the printed object. System 100 may also include a user interface 110, which may be operatively coupled to one or more components, for example, to binder jet fabrication subsystem 101, de-powdering subsystem 103, and sintering furnace subsystem 106, etc. In some embodiments, user interface 110 may be a remote device (e.g., a computer, a tablet, a smartphone, a laptop, etc.). User interface 110 may be wired or wirelessly connected to one or more of binder jet fabrication subsystem 101, de-powdering subsystem 103, and sintering furnace subsystem 106. System 100 may also include a control subsystem 117, which may be included in user interface 110, or may be a separate element.

Binder jet fabrication subsystem 101, de-powdering subsystem 103, sintering furnace subsystem 106, user interface 110, and/or control subsystem 117 may each be connected to the other components of system 100 directly or via a network 111. Network 111 may include the Internet and may provide communication through one or more computers, servers, and/or handheld mobile devices, including the various components of system 100. For example, network 111 may provide a data transfer connection between the various components, permitting transfer of data including, e.g., geometries, the printing material, one or more support and/or support interface details, binder materials, heating and/or sintering times and temperatures, etc., for one or more parts or one or more parts to be printed.

Moreover, network 111 may be connected to a cloud-based application 115, which may also provide a data transfer connection between the various components and cloud-based application 115 in order to provide a data transfer connection, as discussed above. Cloud-based application 115 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of binder jet fabrication subsystem 101, de-powdering subsystem 103, sintering furnace subsystem 106, user interface 110, and/or control subsystem 117. In this aspect, binder jet fabrication subsystem 101, de-powdering subsystem 103, sintering furnace subsystem 106, user interface 110, and/or control subsystem 117 may be disconnected from the Internet and/or other networks, which may increase security protections for the components of system 100. In either aspect, an additional controller (not shown) may be associated with one or more of binder jet fabrication subsystem 101, de-powdering subsystem 103, and sintering furnace subsystem 106, etc., and may be configured to receive instructions to form the printed object and to instruct one or more components of system 100 to form the printed object.

With reference to FIG. 1B, additive manufacturing system 100 may be used to form object 102 from build material, e.g., a powder 104, including inorganic particles (e.g., metallic particles, ceramic particles, or a combination thereof). The three-dimensional object 102 is a green part that, as described in greater detail below, may be subsequently processed (e.g., thermally processed) to form a finished part having a predetermined local variation of one or more physicochemical properties of material formed from the inorganic particles of the powder 104. As used herein, physicochemical properties may include any manner and form of physical properties, chemical properties, or combinations thereof useful for forming a finished part. Examples of physicochemical properties that may be varied by the additive manufacturing system 100 carrying out any one or more of the methods described herein may include, but are not limited to, one or more of the following: melting point, hardness, density, ductility, chemical stability in a given environment, preferred oxidation state, etc.

With continued reference to FIG. 1B, binder jet fabrication system 101 of additive manufacturing system 100 may include a powder supply 112, a print bed 114, a spreader 116, a first printhead 118a, and a second printhead 118b. The spreader 116 may be movable from the powder supply 112 to the print bed 114 and along the print bed 114 to spread successive layers of the powder 104 across the print bed 114. A powder supply actuator 136 may elevate powder supply 112 incrementally as spreader 116 layers powder 104 across print bed 114. Similarly, build box subsystem 108 may comprise a build box actuator 138 that lowers print bed 114 incrementally as each layer of powder is distributed across print bed 114.

The first printhead 118a and the second printhead 118b may be movable (e.g., in coordination with one another and, optionally, in coordination with movement of the spreader 106) across the print bed 114. In general, the first printhead 118a may include one or more orifices 130a through which a first component 119a may be delivered from the first printhead 118a along a controlled two-dimensional pattern in each layer of the powder 104 along the print bed 114, and the second printhead 118b may include one or more orifices 130b through which a second component 119b may be delivered from the second printhead 118b to target locations in at least one layer of a plurality of layers forming the three-dimensional object 102. The first component 119a and the second component 119b may be directed to the powder 104 along the print bed 114 along individually controlled patterns such that the first component 119a, the second component 119b, or both may be present in a given layer of the powder 104 forming the three-dimensional object 102 in any of various different patterns suitable for interacting with one another and/or with the powder 104 to form the three-dimensional object 102 with a material distribution suitable for forming a finished part meeting certain design specifications. For example, as described in greater detail below, the first component 119a and the second component 119b may be segregated between or within in or more layers of the powder 104 or, alternatively, or additionally, the first component 119a and the second component 119b may at least partially overlap one another in one or more layers of the powder 104.

The spreader 116 may include, for example, a roller rotatable about an axis perpendicular to an axis of movement of the spreader 116 across the print bed 114. The roller may be, for example, substantially cylindrical. In use, rotation of the roller about the axis perpendicular to the axis of movement of the spreader 116 may spread the powder 104 from the powder supply 112 to the print bed 114 and form a layer of the powder 104 along the print bed 114. It should be appreciated, therefore, that the plurality of sequential layers of the powder 104 may be formed in the print bed 114 through repeated movement of the spreader 116 across the print bed 114.

The first printhead 118a and the second printhead 118b may include one or more piezoelectric elements (not shown). Each piezoelectric element may be associated with a respective orifice 130a, 130b, of the respective first printhead 118a and second printhead 118b and, in use, each piezoelectric element may be selectively actuated such that displacement of the piezoelectric element may expel liquid from the respective orifice of the respective printhead. In certain implementations, one or both of the first printhead 118a and the second printhead 118b may expel a respective single liquid formulation from the one or more orifices defined by the respective printhead. In some implementations, however, one or both of the first printhead 118a and the second printhead 118b may expel a plurality of liquid formulations from the one or more orifices 130a, 130b, respectively. For example, the first printhead 118a may expel a plurality of solvents, a plurality of components of a binder system, or both from the one or more orifices 130a. As another example, while the first printhead 118a and the second printhead 118b may be separate printheads, it should be appreciated that the first printhead 118a and the second printhead 118b may be combined into a single printhead operable to jet the first component 119a and the second component 119b according to any one or more of the methods described herein.

In general, the first printhead 118a may be controlled to jet one or more inks (e.g., a liquid, a suspension, or a combination thereof) to a layer of the powder 104 along the top of the print bed 114 in a controlled (e.g., predetermined) two-dimensional pattern. As used herein, unless otherwise indicated or made clear from the context, an ink shall be understood to include any manner and type of fluid which can be selectively and controllably deposited along a two-dimensional layer and, accordingly, is not necessarily limited to fluid including color or otherwise used for printing images. Thus, for example, the first printhead 118a may jet one or more inks to one or more layers in a respective controlled two-dimensional pattern associated with the respective ink and a given layer onto which the respective ink is jetted. At least one of the one or more inks jetted by the first printhead 118a may include the first component. Thus, it should be appreciated that the first printhead 118a may be controlled to deliver the first component selectively, as necessary, within and among the layers forming the three-dimensional object 102.

The first printhead 118a may extend axially along substantially an entire dimension of the print bed 114 in a direction perpendicular to a direction of movement of the first printhead 118a across the print bed 114. For example, in such implementations, the first printhead 118a may define a plurality of orifices 130a arranged along the axial extent of the first printhead 118a, and one or more inks may be selectively jetted from these orifices 130a along the axial extent such that each ink may be jetted to one or more of the layers in a respective controlled two-dimensional pattern associated with the respective ink and a given layer onto which the respective ink is jetted along the print bed 114 as the first printhead 118a moves across the print bed 114. Additionally, or alternatively, the first printhead 118a may extend axially along less than an entire dimension of the print bed 114 in a direction perpendicular to a direction of movement of the first printhead 118a across the print bed 114. In such implementations, the first printhead 118a may be movable in two dimensions relative to a plane defined by the print bed 114 to deliver a controlled two-dimensional pattern of a respective ink along a given layer on top of the print bed 114.

The second printhead 118b may include any one or more of the features of the first printhead 118a described herein and, thus, in some implementations, may be substantially identical to the first printhead 118a. Further, or instead, while the additive manufacturing system 100 is described as including the first printhead 118a and the second printhead 118b, other configurations are additionally or alternatively possible for directing the first component 119a and the second component 119b to the print bed 114 to form the three-dimensional object 102. As an example, any one or more features of the second printhead 118b may be incorporated into the first printhead 118a such that the first component 119a and the second component 119b may be delivered through a single printhead. As another example, the first component 119a and the second component 119b may be directed to the print bed 114 through any number of printheads. More generally, any number of components may be directed to the print bed 114 through any number of printheads to form the three-dimensional object 102 processable to form a finished part having a predetermined distribution of one or more physicochemical properties of material formed from the inorganic particles.

The second printhead 118b may be controlled to jet the second component 119b (e.g., as part of an ink or other fluid) to target locations along a layer of the powder 104 on top of the print bed 114. The target locations may, for example, at least partially overlap a controlled two-dimensional pattern of the first component 119a jetted from the first printhead 118a to a given layer onto which the first component 119a is jetted. Additionally, or alternatively, the target locations along which the second component 119b is delivered in a given layer may be segregated from the first component 119a jetted from the first printhead 118a in the given layer.

The distribution of the first component 119a and the second component 119b delivered by the first printhead 118a and the second printhead 118b, respectively, may be useful, for example, for controlling distribution of the first component 119a, the second component 119b, and the powder 104 in the print bed 114 such that the three-dimensional object 102 may be processed (e.g., thermally processed or otherwise densified according to any one or more known densification techniques) to form a finished part having a predetermined local variation of one or more physicochemical properties of the material formed from the inorganic particles of the powder 104. The predetermined local variation of the one or more physicochemical properties in the finished part may be, for example, inhomogeneous in at least one direction.

The binder jet fabrication subsystem 101 may further include a controller 120 in electrical communication with the powder supply 112, the print bed 114, the spreader 116, the first printhead 118a, and the second printhead 118b, and any other components associated with the binder jet fabrication subsystem 101, or the additive manufacturing system 100. The controller 120 may include one or more processors 121 operable to control the powder supply 112, the print bed 114, the spreader 116, the first printhead 118a, the second printhead 118b, and combinations thereof. In use, the one or more processors 121 of the controller 120 may execute instructions to control z-axis movement of one or more of the powder supply 112 and the print bed 114 relative to one another as the three-dimensional object 102 is being formed. For example, the one or more processors 121 of the controller 120 may execute instructions to move the powder supply 112 in a z-axis direction toward the spreader 116 to direct the powder 104 toward the spreader 116 as each layer of the three-dimensional object 102 is formed and to move the print bed 114 in a z-axis direction away from the spreader 116 to accept each new layer of the powder 104 along the top of the print bed 114 as the spreader 116 moves across the print bed 114. Additionally, or alternatively, the one or more processors 121 of the controller 120 may control movement of the spreader 116 from the powder supply 112 to the print bed 114 to move successive layers of the powder 104 across the print bed 114. Further, or instead, the one or more processors 121 of the controller 120 may control the first printhead 118a and the second printhead 118b. For example, the one or more processors 121 of the controller 120 may control movement (e.g., speed, direction, and timing) of the first printhead 118a and the second printhead 118b across the print bed 114.

Alternatively, or additionally, one or more processors 121 of the controller 120 may control movement of the first printhead 118a and the second printhead 118b and the delivery of fluid (e.g., one or more inks) from each of the first printhead 118a and the second printhead 118b. For example, the one or more processors 121 of the controller 120 may control the first printhead 118a to deliver the first component 119a to one or more layers of the powder 104 along the top of the print bed 114. Similarly, the one or more processors 121 of the controller 120 may control the second printhead 118b to deliver the second component 119b to one or more layers of the powder along the top of the print bed 114. In certain implementations, the first printhead 118a may precede the second printhead 118b across the print bed 114 such that the first component 119a may be jetted onto the powder 104 before the second component 119b is jetted onto a given layer of the powder 104. It should be appreciated, however, that the first component 119a and the second component 119b may be jetted toward the print bed 114 in the reverse in certain implementations. Alternatively, or additionally, the first component 119a and the second component 119b may be jetted onto the powder at the same time or at substantially the same time, such as in implementations in which the first printhead 118a and the second printhead 118b are implemented as a single printhead.

The binder jet fabrication subsystem 101 may further include a non-transitory, computer readable storage medium 122 in communication with the controller 120 and having stored thereon a three-dimensional model 124 and instructions for causing the one or more processors 121 to carry out any one or more of the methods described herein. In general, as a plurality of sequential layers of the powder 104 are introduced to the print bed 114 and the first component 119a and the second component 119b are delivered from the respective first printhead 118a and the second printhead 118b to the powder 104 in the print bed 114, the three-dimensional object 102 may be formed according to the three-dimensional model 124 stored in the non-transitory, computer readable storage medium 122. In certain implementations, the controller 120 may retrieve the three-dimensional model 124 in response to user input, and generate machine-ready instructions for execution by the additive manufacturing system 100 to fabricate the three-dimensional object 102. Alternatively, or additionally, spreader 116 may retrieve instructions for forming object 102 from network 112.

In another example embodiment, layers of powder 104 may be deposited onto print bed 114 by a hopper followed by a compaction roller. The hopper may move across print bed 114, depositing powder 104 along the way. The compaction roller may be configured to follow the hopper, spreading the deposited powder to form a layer of powder.

FIG. 1C illustrates another binder jet fabrication subsystem 101′ operating in conjunction with a build box subsystem 108′. As shown in FIG. 1C, binder jet fabrication subsystem 101′ may include a powder supply 112′ in a metering apparatus, for example, a hopper 123. Binder jet subsystem 101′ may also include one or more spreaders 116′ (e.g., one or more rollers) configured to be movable across print bed 114′ of build box subsystem 108′, a first print head 118a′ and a second print head 118b′ movable across print bed 114′, and a controller 120′ in electrical communication (e.g., wireless, wired, Bluetooth, etc.) with one or more of hopper 123, spreaders 116′, and first print head 118a′ and second print head 118b′. Print bed 114′ may comprise powder particles, for example, micro-particles of a metal, micro-particles of two or more metals, or a composite of one or more metals and other materials.

Hopper 123 may be any suitable metering apparatus configured to meter and/or deliver powder from powder supply 120′ onto a top surface 125 of print bed 114′. Hopper 123 may be movable across print bed 114′ to deliver powder from powder supply 112′ onto top surface 125. The delivered powder may form a pile 127 of powder on top surface 125.

The one or more spreaders 116′ may be movable across print bed 114′ downstream of hopper 123 to spread powder, e.g., from pile 127, across print bed 114′. The one or more spreaders 116′ may also compact the powder on top surface 125. In either aspect, the one or more spreaders 116′ may form a layer 126 of powder, e.g., see bottommost layer of powder 104 in FIG. 1C). The aforementioned powder delivery and spreading steps may be successively performed in order to form a plurality of layers 129 of powder. Additionally, although two spreaders 116′ are shown in FIG. 1C, binder jet fabrication subsystem 101′ may include one, three, four, etc. spreaders 116′.

First print head 118a′ and second print head 118b′ may have a similar structure as first print head 118a and second print head 118b. For example, first print head 118a′ and second print head 118b′ may each include one or more piezoelectric elements. Each piezoelectric element may be associated with a respective orifice 130a′, 130b′, in each of first print head 118a′ and second print head 118b′. In certain implementations, first print head 118a′ and second print head 118b′ may be actuated to dispense a binder material (e.g., through delivery of an electric current to each piezoelectric element in mechanical communication with first component 119a′ and second component 119b′) through respective discharge orifices to the layer of powder 104 spread across print bed 114′. In some embodiments, first component 119a′ and second component 119b′ may be one or more fluids configured to bind together powder particles.

In operation, controller 120′ may actuate first print head 118a′ and second print head 118b′ to deliver first component 119a′ and second component 119b′ from each of first print head 118a′ and second print head 118b′, respectively, to each layer 126 of the powder 104 in a pre-determined two-dimensional pattern, as first print head 118a′ and 118b′ move across print bed 114′. As shown in FIG. 1C, controller 120′, including one or more processors 121′, may be in communication with hopper 123 and/or the one or more spreaders 116′ as well, for example, to actuate the movement of hopper 123 and the one or more spreaders 116′ across print bed 114′. Additionally, controller 120′ may control the metering and/or delivery of powder 104 by hopper 123 from powder supply 112′ to top surface 125 of print bed 114′. In example embodiments, the movement of first print head 118a′ and second print head 118b′, and the actuation of first print head 118a′ and second print head 118b′ to deliver first component 119a′ and second component 119b′, may be coordinated with movement of hopper 123 and the one or more spreaders 116′ across print bed 124′. For example, hopper 123 may deliver powder to print bed 124′, and spreader 116′ may spread a layer of the powder across print bed 124′. Then, first print head 118a′ and second print head 118b′ may deliver a binder (e.g., first component 119a′ and second component 119b′) in a pre-determined, two-dimensional pattern, to the layer of the powder spread across print bed 124′, to form a layer of one or more three-dimensional objects 102′. These steps may be repeated (e.g., with the pre-determined two-dimensional pattern for each respective layer) in sequence to form subsequent layers until, ultimately, the one or more three-dimensional objects 102′ are formed in print bed 114′.

Although the example embodiment depicted in FIG. 1C depicts a single object 102′ being printed, it should be understood that the powder print bed 114′ may include more than one object 102′ in embodiments in which more than one object 102′ is printed at once. Further, the powder print bed 114′ may be delineated into two or more layers 129, stacked vertically, with one or more objects disposed within each layer.

As with build box subsystem 108 in FIG. 1B, build box subsystem 108′ may comprise a build box actuator mechanism 138′ that lowers print bed 114′ incrementally as each layer 129 of powder is distributed across print bed 114′. Accordingly, hopper 123, the one or more spreaders 116′, and first print head 118a′ and second print head 118b′ may traverse build box subsystem 108′ at a pre-determined height, and build box actuator mechanism 138′ may lower print bed 114 to form object 102′.

Although not shown, binder jet fabrication subsystems 101, 101′ may include a coupling interface that may facilitate the coupling and/or uncoupling of the build box subsystems 108, 108′ with the binder jet fabrication subsystems 101, 101′, respectively. The coupling interface may comprise one or more of (i) a mechanical aspect that provides for physical engagement, and/or (ii) an electrical aspect that supports electrical communication between the build box subsystem 108, 108′ to the binder jet fabrication subsystem 101, 101′.

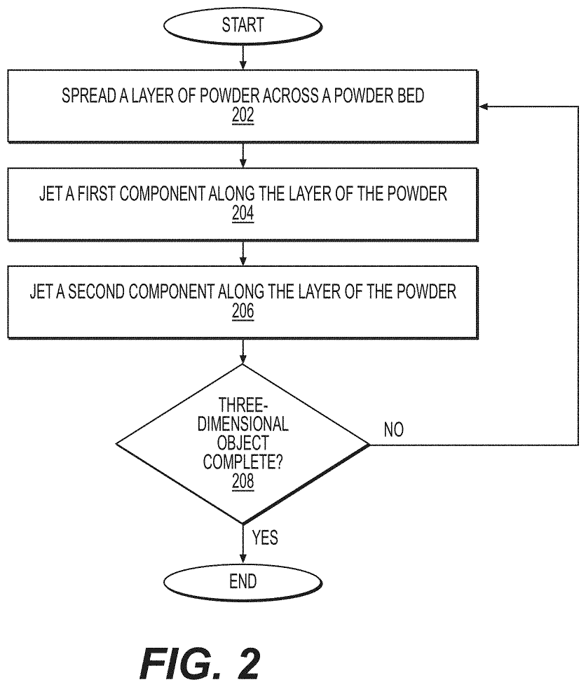

FIG. 2 is a flowchart of an exemplary method 200 of jetting a first component and a second component to layers of a powder to form a three-dimensional object. Unless otherwise specified or made clear from the context, the exemplary method 200 may be implemented using any one or more of the various different additive manufacturing devices and systems described herein. Thus, for example, the exemplary method 200 may be implemented as computer-readable instructions stored on the computer readable storage medium 122 (FIGS. 1B and 1C) and executable by the controller 120, 120′ (FIGS. 1B and 1C) to operate the additive manufacturing system 100 (FIG. 1). Alternatively, or additionally, method 200 may be implemented by receiving instructions from a cloud-based application 115 via network 112.

As shown in step 202, the exemplary method 200 may include spreading a layer of a powder across a powder bed. The powder may include inorganic particles and, more generally, may include any one or more of the powders described herein.

As shown in step 204, the exemplary method 200 may include jetting one or more inks along the layer of the powder. The one or more inks may be, for example, any one or more of the first components described herein. Additionally, or alternatively, each ink may be jetted to the layer in a respective controlled two-dimensional pattern associated with the respective ink and the layer onto which the ink is jetted.

As shown in step 206, the exemplary method 200 may include jetting a second component along the layer of the powder. The second component may be jetted to the layer in a respective controlled two-dimensional arrangement associated with the second component and the layer onto which the second component is jetted. A target distribution of physicochemical properties of material formed from the inorganic particles along the three-dimensional object may be achieved by selectively jetting the first component, the second component, or both along the layer. That is, as necessary, the first component and the second component may be distributed in at least partially overlapping two-dimensional patterns or in segregated patterns in the layer.

As shown in step 208, the exemplary method 200 may include repeating one or more of the steps of spreading a layer of the powder across the powder bed, jetting the first component along a given layer of powder, and jetting the second component along a given layer form the three-dimensional object.

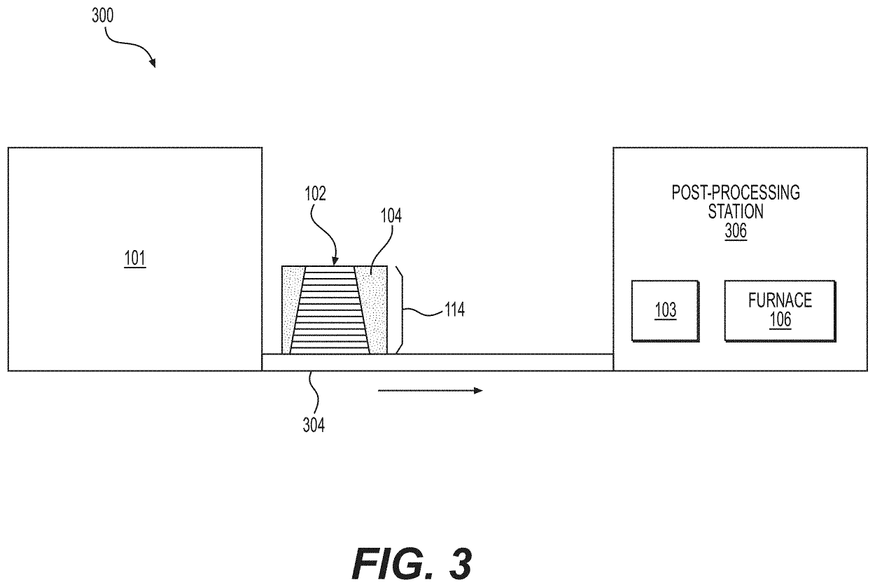

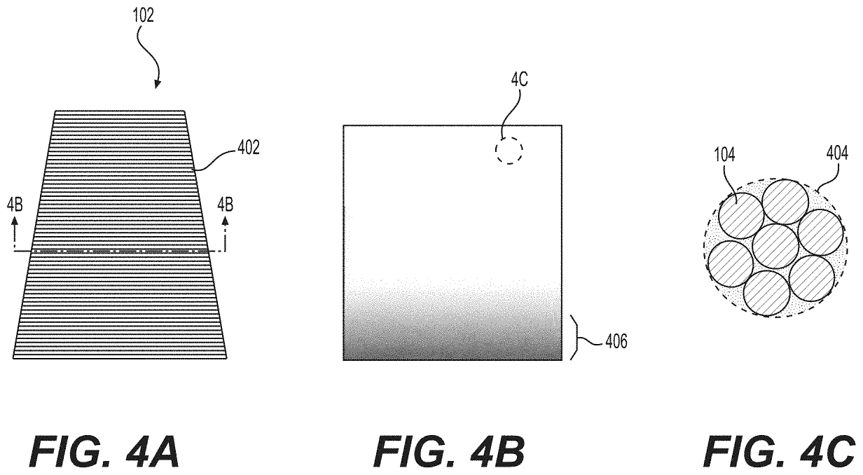

Referring now to FIGS. 1A-1C and 3, an additive manufacturing plant 300 may include binder jet fabrication subsystem 101, 101′, a conveyor 304, and a post-processing station 306. The print bed 114, 114′ containing the three-dimensional object 102, formed as a green part, may be moved along the conveyor 304 and into the post-processing station 306. The conveyor 304 may be, for example, a belt conveyor movable in a direction from the binder jet fabrication subsystem 101, 101′ toward the post-processing station 306. Additionally, or alternatively, the conveyor 304 may include a build box subsystem 108, 108′ on which the print bed 114, 114′ is mounted, respectively, and, in certain instances, the print bed 114, 114′ may be moved from the binder jet fabrication subsystem 101, 101′ to the post-processing station 306 through movement of build box subsystem 108, 108′ (e.g., through the use of actuators to move the cart along rails or by an operator pushing the cart).

In the post-processing station 306, the three-dimensional object 102 may be removed from the print bed 114, 114′. The powder 104 remaining in the print bed 114, 114′ upon removal of the three-dimensional object 102, 102′ may be, for example, recycled for use in subsequent fabrication of additional parts. Additionally, or alternatively, in the post-processing station 306, the three-dimensional object 102 may be cleaned (e.g., through the use of pressurized air) of excess amounts of the powder 104, for example using de-powdering subsystem 103.

In the post-processing station 306, the three-dimensional object 102, 102′ may undergo any of various different densification processes related to the densification of the three-dimensional object 102, 102′ to form a final part. The densification process should be understood to include any process related to the removal of a binder or binder system from the three-dimensional object 102, 102′. Further, or instead, densification processes may include reducing void space between particles in the three-dimensional object 102, 102′.

In certain instances, densification of the three-dimensional object 102, 102′ may include one or more debinding processes in the post-processing station 306 to remove all or a portion of a binder or a binder system from the three-dimensional object 102, 102′. In general, it shall be understood that the nature of the one or more debinding processes may include any one or more debinding processes known in the art and is a function of the constituent components of the binder or binder system. Thus, as appropriate for a given binder or binder system, the one or more debinding processes may include, for example, a thermal debinding process, a supercritical fluid debinding process, a catalytic debinding process, and/or a solvent debinding process. For example, a plurality of debinding processes may be staged to remove components of a binder system in corresponding stages as the three-dimensional object 102, 102′ is formed into a finished part.

Additionally, or alternatively, densification of the three-dimensional object 102, 102′ may include one or more thermal processes in the post-processing station 306. The one or more thermal processes may be part of one or more debinding processes and, further or instead, may reduce void space between particles in the three-dimensional object 102, 102′. The post-processing station 306 may include, for example, de-powdering subsystem 103 or sintering furnace subsystem 106 that may be useful for de-powdering or thermally processing the three-dimensional object 102, 102′ to form a final part.

In certain implementations, thermally processing the three-dimensional object 102, 102′ may include any one or more sintering processes known in the art. That is, through the one or more sintering processes, the inorganic particles of the powder 104 can bond with one another and, optionally, with other substances to form a finished part. Examples of such sintering processes include, but or not limited to, bulk sintering the inorganic particles in the solid state, liquid phase sintering, and transient liquid phase sintering.

In some implementations, thermally processing the three-dimensional object 102, 102′ may include infiltration of a liquid metal through the three-dimensional object 102, 102′. As a specific example, the inorganic particles of the powder 104 forming the three-dimensional object 102, 102′ may be presintered or otherwise bound to form a substantially solid powdered preform. A liquid metal may be infiltrated into the substantially solid powdered preform as part of the thermal processing to form a final part from the three-dimensional object 102, 102′.

Thermally Processable Additive

In certain implementations, any one or more of the devices and systems described herein can be used to carry out the exemplary method of FIG. 2 to form a three-dimensional object (e.g., the three-dimensional object 102, 102′ in FIG. 1) including one or more inks, inorganic particles, and an additive. A powder including the inorganic metallic particles can be held together in the form of the three-dimensional object through one or both of the one or more inks and the additive distributed in layers of the powder. The additive can be thermally processable to alter locally, in the three-dimensional object, one or more physicochemical properties of material formed from the inorganic particles. Through subsequent processing, such as any one or more of the processes described above with respect to FIG. 3, at least one active component in the additive can be thermally processed to alter locally, in the three-dimensional object, one or more physicochemical properties of material formed from the inorganic particles.

In one aspect, an additive manufacturing method may include spreading layers of a powder across a powder bed, the powder including inorganic particles, jetting one or more inks to the layers, each ink jetted to one or more of the layers in a respective controlled two-dimensional pattern associated with the respective ink and a given layer onto which the respective ink is jetted, at least one of the one or more inks including a first binder, and jetting an additive to one or more of the layers to form a respective controlled two-dimensional arrangement of the additive in each layer onto which the additive is jetted, the first binder combining with the layers of the powder and the additive to form a three-dimensional object, and the additive having at least one active component thermally processable to alter locally, in the three-dimensional object, one or more physicochemical properties of material formed from the inorganic particles.

In certain implementations, in at least one of the layers, the additive may at least partially overlap the one or more inks.

In some implementations, the additive manufacturing method may further include thermally processing the three-dimensional object to densify the three-dimensional object to a brown part having a predetermined local variation of the one or more physicochemical properties of the material formed from the inorganic particles. For example, thermally processing the three-dimensional object may include sintering the three-dimensional object. Further, or instead, thermally processing the three-dimensional object may include infiltrating the three-dimensional object with a liquid metal. In certain instances, the predetermined local variation of the one or more physicochemical properties of the material formed from the inorganic particles in the brown part may be inhomogeneous in at least one direction.

In certain implementations, the inorganic particles may include metallic particles. For example, the at least one active component of the additive may be thermally processable to alloy with the material of the metallic particles to alter locally, in the three-dimensional object, one or more physicochemical properties of the metallic particles. As an example, an alloy formed from the material of the metallic particles and the at least one active component of the additive may be embrittled as compared to an alloy formed from the metallic particles alone. That is, more specifically, an alloy formed from the material of the metallic particles and the at least one active component of the additive may be steel, and the at least one active component of the additive may include any one or more of sulfur, phosphorus, antimony, fluorine, bismuth, arsenic, tin, lead, and tellurium. Additionally, or alternatively, an alloy formed from the material of the metallic particles and the at least one active component of the additive may be an aluminum alloy, and the at least one active component of the additive may include gallium. Further, or instead, an alloy formed from the material of the metallic particles and the at least one active component of the additive may be a copper alloy, and the at least one active component of the additive may include one or more of bismuth, antimony, and tellurium.

In some implementations, an alloy formed from the material of the metallic particles and the at least one active component of the additive may be a free-machining material (e.g., a material forming small chips as it is machined, which facilitates machining the material). As an example, an alloy formed from the material of the metallic particles and the at least one active component of the additive may be steel, and the at least one active component of the additive may include one or more of lead and manganese.

In certain implementations, an alloy formed from the material of the metallic particles and the at least one active component of the additive may have a lower melting point than an alloy formed from the metallic particles alone. For example, an alloy formed from the material of the metallic particles and the at least one active component of the additive may be steel, and the at least one active component of the additive may include one or more of carbon and boron.

In some implementations, an alloy formed from the material of the metallic particles and the at least one active component of the additive may have greater corrosion resistance than an alloy formed from the metallic particles alone. For example, the additive may include a chromate solution.

In certain implementations, the inorganic particles may include ceramic particles.

In some implementations, the at least one active component of the additive may include carbon. As specific examples, the additive may include one or more of carbon black, graphene, carbon nanotubes, and silicon carbide.

In certain implementations, the at least one active component of the additive may include boron. As specific examples, the additive may include one or more of pyrolyzed boron nitride, elemental boron, and a salt including boron.

In some implementations, the at least one active component of the additive may include tungsten. As a specific example, the additive may include ammonium paratungstate.

In certain implementations, the at least one active component of the additive may include molybdenum. According to specific examples, the additive may include one or more of ammonium orthomolybdate, ammonium heptamolybdate, ammonium phosphomolybdate, ammonium tetrathiomolybdate.

In some implementations, the additive may include additive particles (e.g., including a metal) stably suspended in a carrier. For example, the additive particles may be hydrophobic. Further or instead, the additive particles may include carbon particles and the carrier may include water and at least one surfactant. The at least one surfactant may include, for example, one or more of an anionic surfactant, a cationic surfactant, a zwitterionic surfactant, and non-ionic surfactant. Additionally, or alternatively, the additive particles may include colloids (e.g., colloids including a size distribution ranging from less than about 5000 nm to greater than about 1 nm). Still further or instead, the additive particles can differ in composition from the inorganic particles of the powder. In specific instances, the additive particles may include one or more of iron and chromium.

In certain implementations, the additive may be dispersed in a carrier. The carrier may be, for example, a second binder. In certain instances, the second binder may be different from the first binder. Further, or instead, at least one of the first binder and the second binder may include polyacrylic acid. Additionally, or alternatively, the carrier may include a solvent, and the additive may be dissolved in the solvent. The solvent may include one or more of water, an aromatic organic substance, an aliphatic organic substance, alcohol, and a surfactant.

In some implementations, the solvent may include a salt. For example, the salt may include a tungsten-containing salt, examples of which include one or more of ammonium paratungstate and ammonium heptamolybdate. As an additional or alternative example, the additive may include a molybdenum-containing salt.

In certain implementations, the additive may be undissolved in the carrier. For example, the carrier may include colloidal particles and a polymer attached to the colloidal particles. The polymer may be, for example, covalently grafted to surfaces of the colloidal particles. As another example, the polymer may be physically adsorbed (e.g., via ionic adsorption) to surfaces of the colloidal particles. Additionally, or alternatively, the polymer may be poly(ethylene glycol) and the colloidal particles may be silicon-based and include a silicon dioxide surface group or, further or instead, the colloidal particles may have a metal oxide surface chemistry. In certain instances, surfaces of the colloidal particles may include an oxide coating, and the polymer is silane-terminated. Also, or instead, the polymer may be thiol-terminated, and the colloidal particles may have a surface group of at least one of gold, platinum, silver, silicon, and silicon dioxide. Still further or instead, the polymer may be carboxyl-terminated, and the colloidal particles may have a surface group of one or more of gold, silver, silver oxide, aluminum oxide, silicon, silicon dioxide, copper, and a coper oxide.

In some implementations, jetting the one or more inks may include delivering the one or more inks from at least one first printhead, and jetting the additive may include delivering the additive from at least one second printhead, the at least one second printhead separate from and independently operable with respect to the at least one first printhead. The at least one second printhead may, for example, follow the at least one first printhead across the powder bed.

In certain implementations, the additive may be substantially along one or more surfaces of the three-dimensional object.

In some implementations, the at least one active component of the additive may include one or more interstitial elements.

Decomposing a Binder of a Powder

Any one or more of the devices and systems described herein may be used to carry out the exemplary method of FIG. 2 to form a three-dimensional object including a plurality of inks and a powder including inorganic particles. At least one ink of the plurality of inks can include a binder holding the powder together in the three-dimensional object. Through subsequent processing, such as any one or more of the processes described above with respect to FIG. 3, at least a portion of the binder may be decomposed at target locations. The decomposition of the binder may yield, for example, at least one active component thermally processable to alter locally, in the three-dimensional object, one or more physicochemical properties of material formed from the inorganic particles.

According to one aspect, an additive manufacturing method may include spreading a plurality of layers of a powder across a powder bed, the powder including inorganic particles, jetting a plurality of inks to the plurality of layers of the powder, each ink jetted to one or more layers of the plurality of layers in a respective controlled two-dimensional pattern associated with the respective ink and a given layer, at least one ink in the plurality of inks including a binder, and the plurality of inks combining with the plurality of layers of the powder to form a three-dimensional object, and decomposing at least a portion of the binder at target locations, the decomposition of the binder yielding at least one active component thermally processable to alter locally, in the three-dimensional object, one or more physicochemical properties of material formed from the inorganic particles.

In certain implementations, the additive manufacturing method may further include thermally processing the three-dimensional object to densify the three-dimensional object to form a brown part having a predetermined local variation of the one or more physicochemical properties of the material formed from the inorganic particles. Thermally processing the three-dimensional object may include, for example, sintering the three-dimensional object. Further, or instead, thermally processing the three-dimensional object may include infiltrating the three-dimensional object with a liquid metal. In certain instances, the predetermined local variation of the one or more physicochemical properties of the material formed from the inorganic particles in the brown part may be inhomogeneous in at least one direction.

In some implementations, decomposing at least a portion of the binder at the target locations may include thermally decomposing at least a portion of the binder.

In certain implementations, the at least one active component may include carbon. For example, the binder at the target locations may have a first char yield and the binder away from the target locations may have a second char yield less than the first char yield.

In some implementations, jetting the plurality of inks may include delivering each ink from a respective printhead, and each printhead may be separate from and independently operable with respect to each of the other printheads.

In certain implementations, the inorganic particles may include metallic particles. For example, the at least one active component yielded from the decomposition of the binder may be alloyable with the metallic particles. An alloy formed from of the metallic particles and the at least one active component may have, for example, a lower melting point than an alloy formed from the metallic particles alone. Further, or instead, an alloy formed from the metallic particles and the at least one active component may be steel, and the at least one active component may include carbon.

In some implementations, the at least one active component may include one or more interstitial elements.

In certain implementations, the target locations may be substantially along one or more surfaces of the three-dimensional object.

Combining Inks to Form an Active Component

Any one or more of the devices and systems described herein may be used to carry out the exemplary method of FIG. 2 to form a three-dimensional object including a plurality of inks, and inorganic particles held together by the plurality of inks. At least one of the inks may include a binder, and at least another one of the inks can chemically modify the binder at target locations to form at least one active component. Through subsequent thermal processing, such as any one or more of the processes described above with respect to FIG. 3, the at least one active component may alter locally, in the three-dimensional object, one or more physicochemical properties of material formed from the inorganic particles.

In certain implementations, an additive manufacturing method may include spreading a plurality of layers of a powder across a powder bed, the powder including inorganic particles, and jetting a plurality of inks to the plurality of layers of the powder, each ink jetted to one or more layers of the plurality of layers in a respective controlled two-dimensional pattern associated with the respective ink and a given layer as the given layer is on top of the powder bed, at least one ink in the plurality of inks including a binder, the plurality of inks combining with the plurality of layers of the powder to form a three-dimensional object, and at least one ink of the plurality of inks chemically modifying the binder at target locations to form at least one active component thermally processable to alter locally, in the three-dimensional object, one or more physicochemical properties of material formed from the inorganic particles.

In some implementations, the additive manufacturing method may further include thermally processing the three-dimensional object to densify the three-dimensional object to form a brown part having a predetermined local variation of the one or more physicochemical properties of the material formed from the inorganic particles. For example, thermally processing the three-dimensional object may include sintering the three-dimensional object. Further, or instead, thermally processing the three-dimensional object may include infiltrating the three-dimensional object with a liquid metal.

In certain implementations, the at least one active component may include one or more interstitial elements.

In some implementations, the inorganic particles may include metallic particles. For example, the at least one active component may be alloyable with the metallic particles to form steel. In certain instances, the additive manufacturing method may further include sintering the three-dimensional object to form a brown part, the brown part including a distribution of an alloy formed from the metallic particles and the at least one active component.

In certain implementations, chemically modifying the binder may include changing volatility of the binder. The binder may include, for example, a salt, and the chemical modification of the salt may change volatility of the salt at the target locations. For example, the binder may include a vanadium salt and, in certain instances, the at least one ink chemically modifying the binder may include an ionic solution (e.g., vanadium chloride) that increases the volatility of the vanadium salt at the target locations. Further, or instead, the at least one ink chemically modifying the binder may include an ionic solution that decreases the volatility of the vanadium salt at the target locations.

In some implementations, jetting the plurality of inks includes delivering each ink from a respective printhead. Each printhead can be, for example, separate from and independently operable with respect to each of the other printheads.

Ink Modifying a Coating on Inorganic Particles

Any one or more of the devices and systems described herein can be used to carry out the exemplary method of FIG. 2 to form a three-dimensional object including a plurality of inks and inorganic particles. The inorganic particles can have a coating. At least one of the inks can be inert with respect to the coating, and at least another one of the inks can be chemically reactive with respect to the coating. For example, at the at least one chemically reactive ink can be chemically reactive with the coating on the inorganic particles to form at least one active component. Through subsequent processing, such as any one or more of the processes described above with respect to FIG. 3, the at least one active component may alter locally, in the three-dimensional object, one or more physicochemical properties of material formed from the inorganic particles. at least one element can be alloyed with the metallic particles at the target locations such that the resulting finished part has a controlled distribution of anisotropic material properties.

According to one aspect, an additive manufacturing method may include spreading a plurality of layers of a powder across a powder bed, the powder including inorganic particles and a coating on the inorganic particles, and jetting a plurality of inks to the plurality of layers of the powder, each ink jetted to one or more layers of the plurality of layers in a respective controlled two-dimensional pattern associated with the respective ink and a given layer as the given layer of the powder is on top of the powder bed, wherein the plurality of inks includes at least one inert ink with respect to the coating on the inorganic particles, the plurality of inks includes at least one chemically reactive ink with the coating on the inorganic particles, and at the at least one inert ink and the at least one chemically reactive ink combining with the plurality of layers of the powder to form a three-dimensional object.

In certain implementations, the at least one chemically reactive ink may be chemically reactive with the coating on the inorganic particles to form at least one active component thermally processable to alter locally, in the three-dimensional object, one or more physicochemical properties of material formed from the inorganic particles. For example, the at least one active component may include an interstitial element.

In some implementations, the additive manufacturing method may include thermally processing the three-dimensional object to densify the three-dimensional object to form a brown part having a predetermined local variation of one or more physicochemical properties of material formed from the inorganic particles. For example, thermally processing the three-dimensional object may include sintering the three-dimensional object. Further, or instead, thermally processing the three-dimensional object may include infiltrating the three-dimensional object with a liquid metal. In certain instances, the predetermined local variation of the one or more physicochemical properties of the material formed from the inorganic particles in the brown part may be inhomogeneous in at least one direction.

In certain implementations, the coating may include a salt and exposure of the salt to the at least one chemically reactive ink reduces volatility of the salt. The salt may be a multivalent salt. Further, or instead, the salt may include ferric ion. Continuing with this example, the at least one chemically reactive ink may include catechol.

In some implementations, the inorganic particles may include metallic particles. For example, the coating may include a polymer tether and an additive. The additive may be tethered to the metallic particles via the polymer tether, the additive may include at least one active component alloyable with the metallic particles. Further, or instead, the at least one chemically reactive ink may be chemically reactive with the polymer tether to unbind the at least one active component from the metallic particles. In certain instances, the polymer tether may be covalently bonded to the metallic particles. In addition, or in the alternatively, the polymer tether may be attached to the metallic particles via physical adsorption. Still further, or in addition, the polymer tether may be attached to the metallic particles via hydrophobic interaction. In further or alternative exemplary implementations, the polymer tether may include one or more of a diblock copolymer, a polyelectrolyte, an acrylate, casein, polystyrene, poly(dimethyl siloxane), and poly(12-hydroystearic acid). Further, or instead, the at least one active component may include at least one of silicon and sulfur. Additionally, or alternatively, the metallic particles may have an oxide layer, and the coating may include a polymer bonded to the oxide layer. Still further, or instead, the polymer may be functionalized with silicon.

In certain implementations, the coating may include a functional group on surfaces of the inorganic particles, and the at least one chemically reactive ink is chemically reactive with the functional group to deposit, locally in a respective layer, at least one active component alloyable with the metallic particles. For example, the inorganic particles, the functional group, or both may include a thiol. As an additional or alternative example, the functional group may include a silanol group that is dehydratable to attach, via a siloxane bond, to the at least one active component alloyable with the metallic particles. As a more specific example, the functional group may include a silane (e.g., perfluorooctyltrichlorosilane).

In some implementations, at least one of the plurality of inks may include polyacrylic acid.

Three-Dimensional Object with Anisotropic Properties

Referring now to FIGS. 1A-IC and 4A-4C, the three-dimensional object 102 formed by the additive manufacturing system 100 according to any one or more of the methods described herein can include a plurality of layers 402 of the powder 104. Each of the layers 402 can include one or more ink 404, such as any one or more of the inks described herein (e.g., the first component 119a and/or the second component 119b in FIG. 1B). Additionally, or alternatively, at least one active component can be distributed in a gradient 406 along the shape of the three-dimensional object 102. The at least one active component can be thermally processable to alter locally, in the three-dimensional object, one or more physicochemical properties of material formed from the inorganic particles to form a predetermined local variation of one or more physicochemical properties of material formed from the inorganic particles in the three-dimensional object. The predetermined local variation can be, for example, inhomogeneous in at least one direction.

According to one aspect, a three-dimensional object can include a plurality of layers of a powder, the powder including inorganic particles, at least one ink dispersed along a respective two-dimensional pattern in each layer, the at least one ink including at least one binder retaining the powder in each layer in the respective two-dimensional pattern associated with the respective layer and binding each layer to one or more adjacent layers to form a shape of the three-dimensional object, and at least one active component distributed along the shape of the three-dimensional object, the at least one active component thermally processable to alter locally, in the three-dimensional object, one or more physicochemical properties of material formed from the inorganic particles to form a predetermined local variation of one or more physicochemical properties of material formed from the inorganic particles in the three-dimensional object, the predetermined local variation inhomogeneous in at least one direction.

In certain implementations, the at least one active component may include an interstitial element.

In some implementations, the at least one active component may be along a surface of the three-dimensional object.

In certain implementations, the inorganic particles may include metallic particles. For example, the metallic particles may be alloyable with the at least one active component. For example, an alloy formed from the metallic particles and the at least one active component may have a greater corrosion resistance than an alloy formed from the metallic particles alone. Additionally, or alternatively, the at least one ink may include a chromate solution. Still further or instead, an alloy formed from the metallic particles and the at least one active component may be embrittled as compared to an alloy formed from the metallic particles alone. As yet an additional or alternative example, the metallic particles and the at least one active component may be alloyable to form steel, and the at least one active component may include any one or more of sulfur, phosphorus, antimony, fluorine, bismuth, arsenic, tin, lead, and tellurium. Further, or instead, metallic particles and the at least one active component may be alloyable to form an aluminum alloy, and the at least one active component includes gallium. In certain instances, the metallic particles and the at least one active component may be alloyable to form a copper alloy, and the at least one active component includes one or more of bismuth, antimony, and tellurium. In some instances, the metallic particles and the at least one active component may be alloyable to form a free-machining material. For example, an alloy formed from the metallic particles and the at least one active component may be steel, and the at least one active component may include manganese.

In some implementations, the metallic particles and the at least one active component may be alloyable to form an alloy having a lower melting point than a melting point of an alloy formed from the metallic particles alone. For example, the metallic particles and the at least one active component may be alloyable to form steel, and the at least one active component may include carbon.

Selective Binder Modification

A problem that exists with respect to the use of a polymer binder including, for example, first component 119a and second component 119b jetted from first printhead 118a and second printhead 118b, respectively, (see FIG. 1B) is that there exists a tradeoff between parts being strong and the difficulty of cleanly burning out the binder from the part. While the use of a greater amount of binder may be useful for forming stronger parts, such an approach to increasing green part strength typically results in leaving more carbon behind during pyrolysis and, in turn, the increased carbon content can compromise quality of the metal composition of the final part. The use of a more highly crosslinked binder may also improve green part strength, but also results in leaving more carbon behind. Accordingly, in the description that follows, binder modification techniques are described for maintaining low levels of carbon contamination during polymer binder pyrolysis while maintaining part strength. Unless otherwise specified or made clear from the context, the following binder modification techniques should be understood to be implemented using the additive manufacturing system 100 (FIG. 1A) according to any one or more of the various different binder jetting techniques described herein. Thus, for example, the first printhead 118a and the second printhead 118b may deliver components of a binder system as necessary or useful for carrying out any one or more of the binder modification techniques described herein.

i. Multiple Binder Deposition

In some implementations, a polymeric binder system for use in binder jetting according to any one or more of the various different binder jetting techniques described herein may include at least first component 119a and second component 119b. The first component 119a (e.g., polyacetal) may be extractable from a three-dimensional object with little carbon contamination as compared to the second component 119b, whereas the second component 119b may provide strength to the green part after extraction of the first component 119a to ensure that the printed object maintains a desired strength during handling and before sintering.

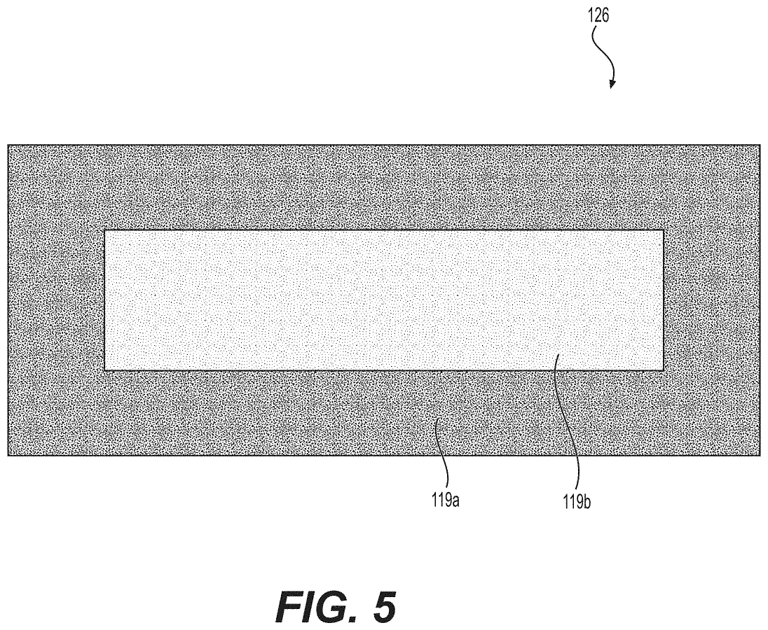

Referring to FIG. 5, the first component 119a may be printed in greater quantities to edges of each layer 126 of 3D object 102. Depositing large quantities of first component 119a along the edges of each layer 126 of powder 104 may provide better edge definition and part strength, as the edges may bear most of the load and sustain all of the abrasion. Printing the first component 119a only at the edges of each layer 126 of powder 104 may allow the first component 119a to be quickly removed by thermal, chemical, or catalytic processes. Since removal of the second component 119b may require additional post-processing time, improved removal speed of the first component 119a be may be useful for achieving overall efficiency in post-processing. As used herein, a part edge should be understood to include a portion of the 3D object 102 defining one or more surfaces along a perimeter of a layer 126 or along a perimeter of any opening within layer 126 of the 3D object 102. For example, the edge may be defined as a surface of a layer 126 extending greater than about 0.2 mm and less than about 5 mm from a perimeter of layer 126 of 3D object 102 toward a center of layer 126 of 3D object 102. The edge may also be understood to include a portion of the 3D object 102 defining one or more surfaces along a perimeter of any opening within layer 126.

The area in which the second component 119b is dispersed may vary according to the required local strength of 3D object 102. For example, the second component 119b may be selectively distributed along portions of a three-dimensional object requiring support (e.g., one or more edges of the three-dimensional object, overhangs, or other structures requiring increased green strength relative to other portions of the three-dimensional object). Through selective distribution of the first component 119a and the second component 119b, the combination of the first component 119a and the second component 119b in the three-dimensional object 102 may lead to reasonable green strength for depowdering/handling the three-dimensional object 102 prior to insertion into the furnace while limiting carbon contamination to levels acceptable for high-quality metal parts. For example, a reasonable green strength may be the ability to handle a three-dimensional object 102 having a cross-sectional thickness of less than approximately 2 mm without breaking the three-dimensional object 102. A reasonable green strength may also be determined as the ability to drop the three-dimensional object 102 onto a hard surface from a height equal to or greater than approximately three inches, without breaking the three-dimensional object 102. It will be understood that these are merely examples, and the reasonable green strength of the three-dimensional object 102 are not limited to these examples. For example, reasonable green strength may depend, e.g., on the typical forces (for example, typical handling) of a green part in a given production situation.

According to an example, the first component 119a may include an oligomer or low molecular weight polymer, such as a waxy oligomer (e.g., a paraffin wax, stearic acid, or a combination thereof), ethylene vinyl acetate, or a low-to-medium molecular weight polystyrene. More generally, the first component 119a may be soluble in any one or more of a variety of solvents at solubility levels sufficient to permit extraction timescales applicable to industrial processes (e.g., which typically ranges from minutes to days). Solubility in the solvent of 5 wt. % of the oligomer or higher is typically preferred for such extraction to be sufficiently rapid, with higher solubility being preferred in most cases. Examples of such solvents include non-polar organic solvents, for example, dichloromethane, perchloroethylene, trans-dicholoroethylene, n-propyl bromide, hexane, and combinations thereof. In instances in which the first component 119a is an oligomer, the first component 119a may provide additional strength as compared to a binder system lacking an oligomer in the first component 119a, and the binder component 119a may be easily extracted in a non-polar solvent. Certain oligomers may further or instead be cleanly evaporated thermally, which may advantageously reduce the need for additional processing steps such as chemical debinding. For example, if the first component 119a includes an oligomer that is cleanly evaporated thermally, a thermal debind cycle in a furnace may be extended and, in turn, the need for chemical processing or other additional processing may be reduced. Many waxes and stearates (including paraffin wax and stearic acid) may be evaporated thermally with little residue.

In certain implementations, the first component 119a may include an oligomer soluble to reasonably high concentrations in a variety of solvents (e.g., water, alcohols, or combinations thereof), e.g., concentrations of approximately 1 wt. %, or approximately greater than or equal to 5 wt. %. Examples of such oligomers may include low-to-medium molecular weight, e.g., oligomers having a molecular weight of approximately 1,000 to 20,000 Daltons, such as but not limited to polyethylene glycol, polyacrylic acid, polyvinyl alcohol, and combinations thereof. In certain instances in which the first component 119a includes a soluble oligomer, the first component 119a may be jetted in large concentrations from first printhead 118a to form a higher concentration of binding agents in a given region. The soluble oligomer forming first component 119a may be chemically removed from the 3D object 102 through, for example, exposure to a solution that selectively dissolves the first binder, while leaving all or most of the second component 119b dispersed throughout the 3D object 102. For example, in some instances, the second component 119b of the binder may be cross-linked with adjacent molecules of the second component 119b after deposition, making the second component 119b insoluble to the solvent. Thus, for example, the same solvent (e.g., water or alcohol) used to jet the entire binder system (e.g., the first component 119a and the second component 119b) may be used to dissolve only a portion of the binder, e.g., the first component 119a, provided the second component 119b of the binder system is crosslinked with the powder 104 before the introduction of the solvent to the 3D object 102 during a chemical debinding step.

In some implementations, the second component 119b may include a polymer that, as compared to the first component 119a, has greater thermal stability, greater molecular weight, and forms a stronger bond between adjacent molecules. Printing the first component 119a on a layer of powder 104 during formation of the 3D object may facilitate use of smaller amounts of the second component 119b, while also promoting a sufficient size, shape, and/or strength of the 3D object 102 is maintained before sintering and/or during handling. Because the second component 119b is present in a smaller amount in the 3D object 102, the second component 119b may both be cross-linked with the powder 104 of the 3D object 102 and may achieve a smaller carbon contamination. The decreased carbon contamination may be proportional to the reduction in volume of the cross-linked second component 119b.

As described herein, the first component 119a and the second component 119b may be jetted independently from one another through separate printheads, e.g., jetting first component 119a using first printhead 118a and jetting second component 119b using second printhead 118b, or vice versa. Such independent jetting may be useful, for example, for independently controlling the amount of first component 119a and second component 119b deposited into each area of the 3D object 102. Such independent control may be useful, for example, for substantially independently controlling gradients of clean removal and high-strength components. For example, a volume (e.g., an amount) of first component 119a jetted on the 3D object 102 may be greater than a volume (e.g., an amount) of second component 119b jetted on the 3D object 102, and vice versa.

While the first component 119a and the second component 119b have been described as being delivered separately through the first printhead 118a and the second printhead 118b, respectively, it should be appreciated that the first component 119a and the second component 119b may be jetted from the same printhead. Moreover, it will be understood that first component 119a′ and second component 119b′ may be applied to powder 104 of layer 126 in a similar manner as first component 119a and second component 119b, as described above. It will also be understood that first component 119a or second component 119b may be selectively crosslinked and/or may be selectively activated to provide various levels of strength to a green part of object 102. Selective crosslinking and selective activation of binders is described in greater detail herein.

ii. Selective Crosslinking

In certain implementations, a polymeric binder system for use in binder jetting according to any one or more of the various different binder jetting techniques described herein may include at least one selectively activatable component, with the selective activation increasing crosslinking of the component. For example, the selectively activatable component may be activated through deposition of a crosslinking agent locally to increase cross-linking in one or more predetermined sections of the three-dimensional object. Further, or instead, the selectively activatable component may be activated through exposure to an activating energy source, such as a photon light source (e.g., a UV light source), a laser, selective heating, or a combination thereof. In general, the selectively activatable component may be cross-linked as may be useful for balancing the competing design considerations with respect to improved strength in green parts while limiting carbon contamination.

In certain implementations, the binder including the selectively activatable component may be distributed from a printhead (e.g., the first printhead 118a in FIG. 1B) toward a powder bed as part of a binder jetting manufacturing process. An activator may be selectively applied to the binder at one or more predetermined locations along which increased strength is desirable in the three-dimensional object. Selectively applying the activator may include, for example, selectively distributing a chemical cross-linking agent from another printhead (e.g., the second printhead 118b in FIG. 1B). As an example, the selectively activatable component may be polyacrylic acid (PAA), and the chemical cross-linking agent may be glycerol. While selectively distributing a chemical cross-linking agent may be carried out in some instances, other distributions of the chemical cross-linking agent may additionally or alternatively be carried out. For example, the chemical cross-linking agent may be distributed along with the selectively activatable component along a controlled two-dimensional pattern on a layer on top of the powder bed, and an energy source (e.g., light energy or thermal energy) may be selectively directed toward the controlled two-dimensional pattern to initiate cross-linking in targeted areas along the controlled two-dimensional pattern. As an example, the chemical cross-linking agent may be activatable by UV light, and a controlled pattern of UV light may be projected onto the controlled two-dimensional pattern to initiate selective crosslinking. As an additional or alternative example of curing using UV light, the cross-linking agent may be distributed along an outer edge of the three-dimensional object, and the three-dimensional object may be placed in a UV chamber to selectively cure the cross-linking agent and the selectively activatable component along the outer edge of the three-dimensional object.

While selective activation has been described including the use of a chemical cross-linking agent, other types of energy (e.g., light energy or thermal energy) may be additionally or alternatively used to activate the selectively activatable component. As an example, a waxy oligomer with acrylate end groups (e.g., a waxy diacrylate) may be selectively crosslinked by exposure to an activating light. Activation of such a waxy oligomer may be achieved, for example, through the use of any of a number of photoinitiators known in the art for UV curing of acrylates to create a UV-activated polymerizable binder, and exposing the UV-activated polymerizable binder to UV light to achieve targeted cross-linking. The waxy oligomeric portions may facilitate, for example, burning out the polymerized binder somewhat cleanly compared as compared to traditional acrylate systems. Using bi-functional diacrylate systems may advantageously facilitate polymerization in lines, instead of networks, to create strongly crosslinked systems that are not overly-crosslinked. Increasing the average functionality of the oligomers used in this process may vary (e.g., continuously) the strength-carbon-content tradeoff in a way that may be spatially modulated via exposure to UV light. In certain instances, a UV curing system may include an acrylate system (e.g., polyethylene glycol-diacrylate).

In general, activation using UV light may be carried out by any of various different approaches useful for forming a targeted curing pattern. Thus, for example, UV light may be directed to a layer of powder using digital light processing (DLP) to project an image onto the layer of the powder, which may be useful for forming a pattern rapidly. Additionally, or alternatively, UV light may be directed to a layer of powder using a laser to trace a targeted cross-linking pattern.

iii. Crosslinking End Groups

In certain implementations, a polymeric binder system for use in binder jetting according to any one or more of the various different binder jetting techniques described herein may include a component that may be crosslinked through difunctional crosslinking only at end-groups to form a polymer. As compared to the large number of bonds associated with higher order crosslinking (e.g., trifunctional crosslinking), a component that crosslinks only at end-groups may form a low-connectivity polymer network that advantageously provides strength improvement while also being cleanly removable through pyrolysis.

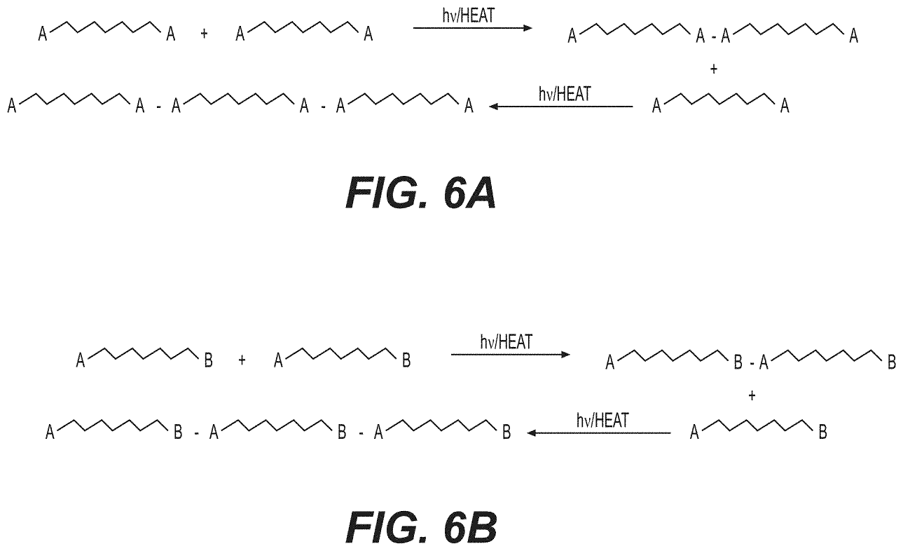

Referring now to FIG. 6A, in-situ polymerization of oligomers A-A may be achieved through activation without exposure to other chemical species. In general, the oligomers A-A may have symmetric end groups such that energy directed to the oligomers A-A may bind the oligomers A-A to one another in any orientation. As an example, energy in the form of light energy, thermal energy, or a combination thereof, may be directed to the oligomers A-A to bind the oligomers A-A at the end-groups of the oligomers A-A. Thus, for example, a polymeric binder including the oligomers A-A may be distributed along a controlled two-dimensional pattern along a powder bed, and light energy (e.g., UV light) may be selectively directed at the oligomers A-A along the controlled two-dimensional pattern to bind end-groups of the oligomers. Through such binding, the molecular weight of the polymeric binder may increase without becoming entangled in a tightly chemically bound network. Additionally, or alternatively, for certain types of oligomers A-A, thermal energy may be selectively directed at the oligomers A-A along the controlled two-dimensional pattern to bind end-groups of the oligomers A-A. As an example, the oligomers A-A may include acrylate.

Referring now to FIG. 6B, in-situ polymerization of oligomers A-B may be achieved through activation without exposure to other chemical species. In general, the oligomers A-B may have asymmetric end groups such that energy directed to the oligomers A-B may bind the oligomers A-B to one another in appropriate orientation. For example, energy in the form of light energy, thermal energy, or a combination thereof, may be directed to the oligomers A-B to bind the oligomers A-B at the end-groups of the oligomers A-B. The selective delivery of activation energy to the oligomers A-B may increase the molecular weight of the polymeric binder while reducing the likelihood of carbon contamination as the polymer is pyrolyzed during subsequent processing. As an example, the oligomers A-B may include ester bonds, amide bonds.

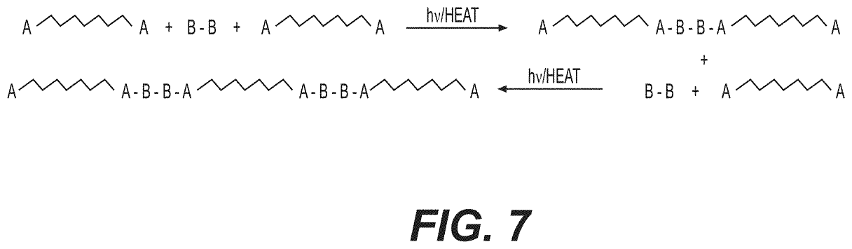

Referring now to FIG. 7, in-situ polymerization of oligomers may be achieved through activation additionally, or alternatively, a polymeric binder including oligomers A-A and a cross-linking species B-B. For example, light energy, thermal energy, or a combination thereof may be directed to the oligomers and the cross-linking species B-B. Any one or more forms of energy described herein (e.g., light energy, such as UV light, or thermal energy) may be selectively directed at the polymeric binder to initiate in-situ polymerization via reaction of the cross-linking species with the oligomers A-A.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

While reference may be made to certain elements in one example, e.g., reference to first component 119a and second component 119b in FIG. 1B, the description of these elements applies equally to like elements, e.g., first component 119a′ and 119b′ in FIG. 1C, respectively, unless explicitly stated otherwise.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. An additive manufacturing method, the method comprising:
depositing a first amount of metal powder onto a print bed, the first amount of metal powder forming a first layer;
depositing a first binder component onto the first layer in a first region; and
depositing a second binder component onto the first layer in a second region.

2. The method according to claim 1, wherein a thermal stability of the first binder component is less than a thermal stability of the second binder component.

3. The method according to claim 2, wherein the first region completely surrounds the second region in a plane.

4. The method according to claim 1, wherein the first region and the second region do not overlap.

5. The method according to claim 1, wherein an outer edge of the first region is defined by a perimeter of the first layer.

6. The method according to claim 5, wherein the first region extends from the outer edge toward a center region of the first layer by a distance of approximately 0.2 mm to approximately 5 mm.

7. The method according to claim 1, wherein the second binder component crosslinks with the first binder component along an overlap between the first region and the second region.

8. The method according to claim 1, further comprising:
depositing a second amount of metal powder, depositing the first binder component, and depositing the second binder component to form a three-dimensional (3D) object.

9. The method according to claim 1, further comprising:
activating one of the first component or the second component, wherein activating one of the first component or the second component includes changing a physical characteristic of the one of the first component or the second component.

10. The method according to claim 9, wherein activating one of the first component or the second component includes depositing an additional material on the first component or the second component.

11. A method of additive manufacturing, the method comprising:
forming a plurality of layers of a powder on a print bed layer by layer;
depositing a first binder component onto at least one layer of the plurality of layers in a first region; and
depositing a second binder component onto the at least one layer of the plurality of layers in a second region.

12. The method according to claim 11, wherein the first region and the second region do not overlap.

13. The method according to claim 11, further comprising:
depositing one of the first binder component or the second binder component on an additional layer of the plurality of layers, and wherein another of the first binder component or the second binder component is not deposited on the additional layer of the plurality of layers.

14. The method according to claim 11, wherein the first region completely surrounds the second region in a plane.

15. The method according to claim 14, wherein the first binder component does not form crosslinking bonds, and wherein the second binder forms crosslinking bonds.

16. An additive manufacturing method, the method comprising:
depositing a first amount of metal powder on a print bed, the first amount metal powder forming a first layer;
depositing a first binder component onto the first layer in a first region, wherein the first binder component is applied in a first concentration; and
depositing a second binder component onto the first layer in a second region, wherein the second binder component is applied in a second concentration different from the first concentration.

17. The system according to claim 16, wherein a thermal stability of the first binder component is less than a thermal stability of the second binder component.

18. The system according to claim 16, wherein the first region and the second region do not overlap.

19. The system according to claim 16, wherein an outer edge of the first region is defined by a perimeter of the first layer.

20. The system according to claim 19, wherein the first region extends from the outer edge toward a center region of the first layer by a distance of approximately 1 mm to approximately 5 mm.
